(19) United States
(12) Patent Application Publication
(10) Pub. No.: US 2024/0311203 A1
(43) Pub. Date: Sep. 19, 2024

(54) BATCH PROCESSING SYSTEM FOR MEC ORCHESTRATION

(71) Applicant: Lenovo (Beijing) Limited, Beijing (CN)

(72) Inventors: David Wayne COSBY, Raleigh, NC (US); Caihong ZHANG, Beijing (CN); Fred Allison BOWER, III, Durham, NC (US)

(21) Appl. No.: 18/482,452

(22) Filed: Oct. 6, 2023

(30) Foreign Application Priority Data
Mar. 14, 2023 (CN) 202310250582.8

(51) Int. Cl. G06F 9/50

(52) U.S. Cl. CPC G06F 9/505; G06F 9/5072

(57) ABSTRACT

A batch processing method includes receiving a register request from an edge node, determining a queue priority of a batch workload for batch processing of edge-node data in a batch workload line of a Multi-Access Edge Computing (MEC) compute service host, and instructing the MEC compute service host to place the batch workload in the batch workload line according to the determined priority. The register request requests a service of the MEC compute service host for batch processing of the edge-node data stored in a data buffer of the edge node.

### CROSS-REFERENCE TO RELATED APPLICATION

This application claims priority to Chinese Application No. 2023102505828, filed on Mar. 14, 2023, the entire content of which is incorporated herein by reference.

### TECHNICAL FIELD

The present disclosure relates to data processing technologies and, more particularly, to a batch processing method for Multi-Access Edge Computing (MEC) orchestration and a MEC orchestration host.

### BACKGROUND

As edge computing emerges as a distributed information technology (IT) paradigm, the development or refactoring of applications into containerized micro-services with service mesh orchestration is causing infrastructure to be deployed as a utility for many environments. Multi-Access Edge Computing (MEC) is a typical architectural approach to provide this utility. As a utility, MEC compute service hosts end up with multiple workloads concurrently executing on the same host hardware. There is no good way to indicate in a MEC environment that services are conditionally needed only if the network has slack in its bandwidth and processing capability. Further, edge nodes may have the capacity to buffer data for MEC service processing for a period of time. Currently, there is no dialogue between these buffers and the MEC services to enable effective coordination of priority to optimize the use of the MEC services.

In conventional mesh/MEC environments, the container orchestration places workload based upon availability of capacity in the network and demand of the workload. For edge nodes that have registered a need for processing, the orchestration will prioritize to meet service-level agreement (SLA) constraints to the extent that the edge has conveyed priority or that priority is implicit in the workload service request. This has the drawback of being a static prioritization without any context of the full set of service being hosted by the MEC environment and also without any sense of temporal priority.

### SUMMARY

In accordance with the disclosure, there is provided a batch processing method including receiving a register request from an edge node, determining a queue priority of a batch workload for batch processing of edge-node data in a batch workload line of a Multi-Access Edge Computing (MEC) compute service host, and instructing the MEC compute service host to place the batch workload in the batch workload line. The register request requests a service of the MEC compute service host for batch processing of the edge-node data stored in a data buffer of the edge node.

Also in accordance with the disclosure, there is provided a batch processing method including allocating a data buffer for a batch workload, starting capturing data into the data buffer, and sending a register request to a Multi-Access Edge Computing (MEC) orchestration host. The register request requests a service of a MEC compute service host for batch processing of the data stored in the data buffer.

Also in accordance with the disclosure, there is provided a Multi-Access Edge Computing (MEC) orchestration host including at least one memory and at least one processor coupled to the at least one memory. The processor is configured to receive a register request from an edge node, determine a queue priority of a batch workload for batch processing of edge-node data in a batch workload line of a MEC compute service host, and instruct the MEC compute service host to place the batch workload in the batch workload line. The register request requests a service of the MEC compute service host for batch processing of the edge-node data stored in a data buffer of the edge node.

### BRIEF DESCRIPTION OF THE DRAWINGS

FIG. 1 is a schematic diagram showing an architecture of a batch processing system for Multi-Access Edge Computing (MEC) orchestration consistent with embodiments of the disclosure.

FIG. 2 is a schematic diagram showing a MEC orchestration host consistent with embodiments of the disclosure.

FIG. 3 is a flow chart illustrating a batch processing method for MEC orchestration consistent with embodiments of the disclosure.

FIG. 4 is a flow chart illustrating another batch processing method for MEC orchestration consistent with embodiments of the disclosure.

FIG. 5 is a flow chart illustrating another batch processing method for MEC orchestration consistent with embodiments of the disclosure.

FIG. 6 is a flow chart illustrating another batch processing method for MEC orchestration consistent with embodiments of the disclosure.

FIG. 7 schematically illustrates placing the batch workload into the batch workload line consistent with embodiments of the disclosure.

FIG. 8 shows a working flow chart of a batch processing system for MEC orchestration consistent with embodiments of the disclosure.

### DETAILED DESCRIPTION OF THE EMBODIMENTS

Hereinafter, embodiments consistent with the disclosure will be described with reference to the drawings, which are merely examples for illustrative purposes and are not intended to limit the scope of the disclosure. Wherever possible, the same reference numbers will be used throughout the drawings to refer to the same or like parts.

The present disclosure provides a batch processing method for Multi-Access Edge Computing (MEC) orchestration and a MEC orchestration host. The host utilizes a collaboration between edge nodes with data buffers and a MEC compute service host. The data buffers can be configured for storing data for batch processing. Each edge node can send a registration request including a registration of the batch processing and a deadline for the batch processing to a MEC orchestration host to request the MEC compute service host to perform the batch processing of the data stored in the edge node before the deadline. As the deadline approaches, the MEC orchestration host can increase a priority of the batch processing. At the deadline, the edge node can reallocate the buffer to new data and the batch job associated with the unserviced data can be canceled. As such, high-value MEC services can be given more capacity at peak demand times and the batch jobs can still be serviced on a best-effort basis with maximum utilization of the MEC service host. In an environment where sufficient capacity exists, an overall responsiveness of the system can be improved by assigning the batch workload to troughs in demand, thereby prioritizing bandwidth and compute capacity for the high-priority services.

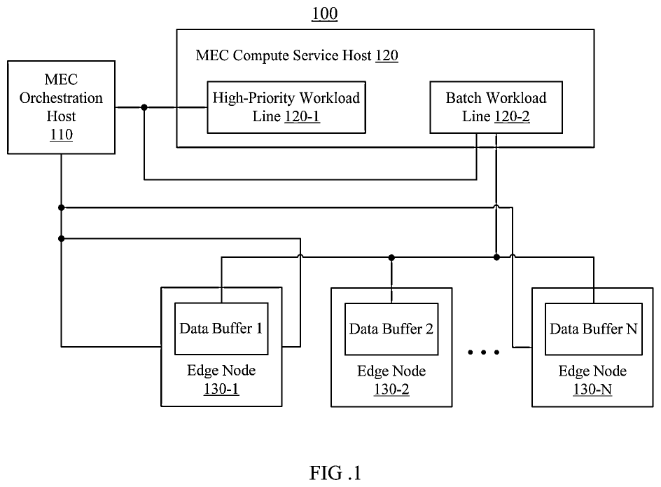

FIG. 1 is a schematic diagram showing an architecture of an example batch processing system 100 for MEC orchestration consistent with the disclosure. As shown in FIG. 1, the batch processing system 100 includes a MEC orchestration host 110, a MEC compute service host 120 communicatively coupled to the MEC orchestration host 110 via, e.g., a wireless connection, and a plurality of edge nodes 130-1 to 130-N communicatively coupled to the MEC orchestration host 110 and the MEC compute service host 120 via, e.g., wireless connections. A wireless connection can include a connection based on Wi-Fi, Long Term Evolution (LTE), 4G, 5G, or the like.

Each of the plurality of edge nodes 130-1 to 130-N can include one or more mobile devices (e.g., mobile phones, smart watches, tablets, and/or the like), one or more sensing devices (e.g., cameras, temperature sensors, and/or the like), and/or one or more other Industrial Internet of Things (IIoT) type devices. Each edge node can include at least one processor and at least one data buffer coupled to the at least one processor. For example, as shown in FIG. 1, the edge node 130-1 includes data buffer 1, the edge node 130-2 includes data buffer 2, and the edge node 130-N includes data buffer N. The at least one processor can include any suitable hardware processor, such as a microprocessor, a micro-controller, a central processing unit (CPU), a network processor (NP), a digital signal processor (DSP), an application specific integrated circuit (ASIC), a field-programmable gate array (FPGA), and/or another programmable logic device, a discrete gate or transistor logic device, a discrete hardware component. The at least one data buffer can include a non-transitory computer-readable storage medium, such as a random-access memory (RAM), a read only memory, a flash memory, a volatile memory, a hard disk storage, or an optical medium. In some embodiments, the non-transitory computer-readable storage medium can also store instructions for executing by the one or more processors to perform a method consistent with the disclosure. In some embodiments, the instructions can be stored in a separate non-transitory computer-readable storage medium other than the at least one data buffer. The separate non-transitory computer-readable storage medium can include, e.g., a random-access memory (RAM), a read only memory, a flash memory, a volatile memory, a hard disk storage, or an optical medium.

Each edge node can capture data into its data buffer and the data buffer can be configured to store data for a batch workload. The batch workload may refer to an instance of any application or task that can be executed by a server but does not need to be executed in real time. Taking a video camera as an example of the edge node, video data captured by the video camera can be stored in a data buffer of the video camera, and thus a processing of the video data can be performed at a later time. For example, when the video camera is used to monitor a parking lot, the monitoring video may only need to be processed, e.g., once a week or when some special events happened, and the batch workload may include a video processing application, e.g., an application for detecting cars in the monitoring video.

The MEC computer service host 120 can include at least one processor configured to execute workloads and at least one memory coupled to the processor. The at least one processor can include any suitable hardware processor, such as a microprocessor, a micro-controller, a central processing unit (CPU), a network processor (NP), a digital signal processor (DSP), an application specific integrated circuit (ASIC), a field-programmable gate array (FPGA), and/or another programmable logic device, a discrete gate or transistor logic device, a discrete hardware component. The at least one data buffer can include a non-transitory computer-readable storage medium, such as a random-access memory (RAM), a read only memory, a flash memory, a volatile memory, a hard disk storage, or an optical medium.

In some embodiments, the MEC computer service host 120 can include, for example, a data center installed at a wireless access station. The data center can include a plurality of servers configured to execute the workloads. The workloads may include high-priority workloads and/or the batch workloads. As shown in FIG. 1, the MEC computer service host 120 can be configured to create two lines for an access to hardware of the MEC computer service host 120, i.e., a high-priority workload line 120-1 for queueing the high-priority workloads and a batch workload line 120-2 for queueing the batch workloads in a priority order, i.e., ordered according to the priorities of the batch workloads. In some embodiments, the high-priority workload may refer to an instance of any application or task that is to be executed by a server in real time. For example, when a user is waiting at a bus station, he may try to check on an arrival time for the next bus, which needs an immediate response. In some other embodiments, the high-priority workload may refer to an instance of any application or task provided by a high-priority customer.

The MEC orchestration host 110 can include a platform or a server that can execute an orchestration service. The MEC orchestration host 110 can be configured to perform a workload scheduling (i.e., control an execution/priority order of the workloads). For example, the MEC orchestration host 110 can determine which of the high-priority workload line 120-1 and the batch workload line 120-2 can obtain a service of the MEC computer service host 120 next. There can be dialogues established between the MEC orchestration host 110 and the plurality of edge nodes 130-1 to 130-N. Each edge node can register with the MEC orchestration host 110 to request the service capability of the MEC computer service host 120. The MEC orchestration host 110 can determine a priority of the batch workload from the edge node based upon, for example, a deadline associated with the batch workload. The MEC computer service host 120 can place the batch workload in the batch workload line 120-2 according to the determined priority. The MEC computer service host 120 can be configured to watch the service available for the batch workload, pool the data from the data buffer of the corresponding edge node, and process the batch workload.

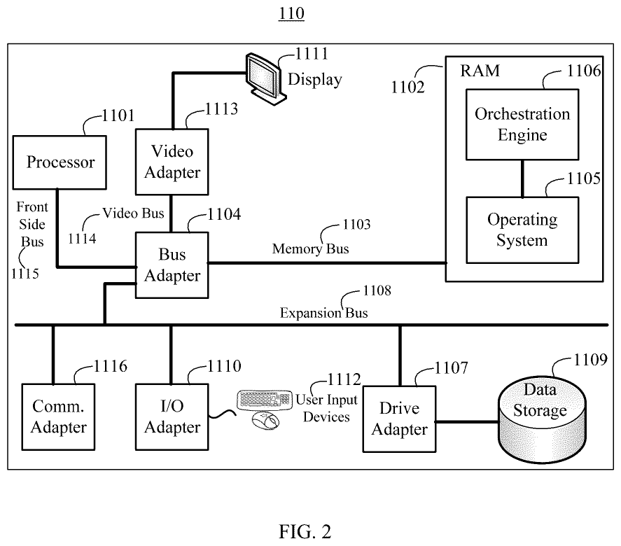

FIG. 2 is a schematic diagram of an example MEC orchestration host 110 consistent with the disclosure. As shown in FIG. 2, the MEC orchestration host 110 includes at least one processor 1101 and at least one random access memory (RAM) 1102 coupled to the processor 1101 through a high-speed memory bus 1103 and a bus adapter 1104.

The RAM 1102 can be configured to store an operating system 1105. The operating system 1105 can include UNIX, Linux, Microsoft Windows, AIX, and the like. In some embodiments, some components of the operating system 1105 can be stored in a non-volatile memory, for example, on a disk drive. The RAM 1102 can also be configured to store an orchestration engine or application 1106. The orchestration engine 1106 can include computer program instructions for performing the workload scheduling.

The MEC orchestration host 110 further includes a disk drive adapter 1107 coupled to the processor 1101 and other components of the host 110 through an expansion bus 1108 and the bus adapter 1104. The expansion bus 1108 may be an interconnect fabric. The disk drive adapter 1107 can couple a non-volatile data storage 1109 to the MEC orchestration host 110 in the form of the disk drive. The disk drive adapter 1107 can include an Integrated Drive Electronics (IDE) adapter, a Small Computer System Interface (SCSI) adapter, or the like. The non-volatile data storage 1109 can include an optical disk drive, an electrically erasable programmable read-only memory (EEPROM), or the like.

The MEC orchestration host 110 further includes one or more input/output (I/O) adapters 1110. The one or more I/O adapters 1110 can implement user-oriented inputs/outputs through, for example, software drivers and/or computer hardware for controlling outputs to, e.g., a display device 1111 (e.g., a display screen or a computer monitor), and/or user inputs from, e.g., user input devices 1112 (e.g., a keyboard and mouse). The MEC orchestration host 110 further includes a video adapter 1113 configured for graphic output to the display device 1111. The video adapter 1113 is coupled to the processor 1101 through a high-speed video bus 1114, the bus adapter 1104, and a front side bus 1115.

The MEC orchestration host 110 further includes a communications adapter 1116 for data communications with the wireless network. The communications adapter 1116 can include, for example, an IEEE 802.11 adapter for wireless data communication, or the like. The communications adapter 1116 can perform data communications, through which the MEC orchestration host 110 can communicate with the MEC compute service host 120 and the plurality of edge nodes 130-1 to 130-N.

It is intended that modules and functions described in the example MEC orchestration host be considered as exemplary only and not to limit the scope of the disclosure. It will be appreciated by those skilled in the art that the modules and functions described in the example MEC orchestration host may be combined, subdivided, and/or varied.

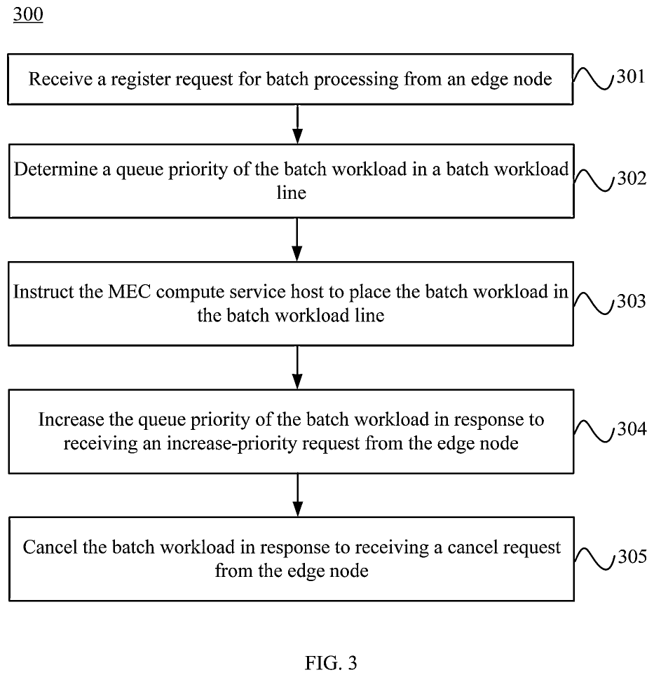

For further explanation, FIG. 3 sets for an example batch processing method 300 for MEC orchestration consistent with the disclosure. The method 300 can be implemented by a MEC orchestration host of a batch processing system for MEC orchestration consistent with the disclosure, such as the MEC orchestration host 110 of the batch processing system 100 described above.

As shown in FIG. 3, at 301, a register request for batch processing is received from an edge node. The MEC orchestration host can receive the register request from the edge node via a wireless network. The wireless connection can include Wi-Fi, Long Term Evolution (LTE), 4G, 5G, or the like. The register request may request a service of a MEC compute service host for batch processing of data stored in a data buffer of the edge node. In this disclosure, the data stored in the data buffer of the edge node is also referred to as “edge-node data.” The batch processing of data refers to executing an associated batch workload using the data stored in the data buffer of the edge node.

In some embodiments, the register request can further include a deadline for the batch processing. That is, the edge node can request the batch processing for the data stored in its data buffer to be performed before the deadline. In some embodiments, the deadline for the batch processing can be a deadline for the data buffer of the edge node. For example, the deadline can be a time period after which the data buffer will run out of buffer space. The deadline can be determined based upon a capacity of the data buffer of the edge node or an amount of data captured per unit time. For example, the deadline can be determined by a quotient of the capacity of the data buffer divided by the amount of data captured per unit time. For example, if the data buffer will run out of buffer space after 24 hours, the deadline can be set to be 24 hours, i.e., the edge node can request the MEC compute service host to perform the batch processing of the data within 24 hours from a current time, i.e., the time the MEC compute service host receives the register request. As another example, the deadline can be a specific time, e.g., 2:30 pm.

In some other embodiments, the register request may not include the deadline for the batch processing. For example, the edge node may be capturing a very small amount of data every day, and the data buffer may be able to store a working history of a very long time (e.g., two years). That is, the amount of daily captured date is very small as compared to the storage capacity of the data buffer. In this scenario, as long as the data is eventually processed, it does not matter how soon the data is processed, and the data most likely will be processed before the data buffer is fully occupied. As such, the register request may not need to include the deadline and can just request the MEC compute service host to execute the workload whenever the MEC compute service host has time.

At 302, a queue priority of the batch workload in a batch workload line is determined. The MEC orchestration host can determine the queue priority of the batch workload in the batch workload line of the MEC compute service host. The MEC compute service host can have two lines for an access to hardware of the MEC computer service host, i.e., a high-priority workload line and the batch workload line, such that the batch workload can be placed without occupying a place in the high-priority workload line.

In some embodiments, the queue priority of the batch workload for the edge node can be determined according to the deadline. For example, the queue priority of the batch workload can be determined by comparing the deadline of the batch workload with those of other batch workloads in the batch workload line. An earlier deadline can correspond to a higher queue priority and a later deadline can correspond to a lower queue priority. For example, a batch workload having a deadline at 2:00 pm can have a higher queue priority than another batch workload having a deadline at 3:00 μm.

In some embodiments, the queue priority of the batch workload for the edge node can be determined according to a combination of the deadline and other factors (e.g., a customer priority indicating an importance of a customer to whom the edge node belongs or the like). For example, the queue priority of the batch workload for the edge node can be first determined by comparing the customer priority of the batch workload with those of the other batch workloads in the batch workload line. A higher customer priority can correspond to a higher queue priority and a lower customer priority can correspond to a lower queue priority. The queue priority of the batch workload for the edge node can then be determined by comparing the deadline of the batch workload with those of the other batch workloads having the same customer priority in the batch workload line. That is, for the other batch workloads having the same customer priority as the batch workload for the edge node, an earlier deadline can correspond to a relatively higher queue priority and a later deadline can correspond to a relatively lower queue priority.

As another example, the queue priority of the batch workload for the edge node can be first determined by comparing the deadline of the batch workload with those of the other batch workloads in the batch workload line. An earlier deadline can correspond to a higher queue priority and a later deadline can correspond to a lower queue priority. The queue priority of the batch workload for the edge node can be then determined by comparing the customer priority of the batch workload with those of the other batch workloads having the same or similar deadline in the batch workload line. That is, for the other batch workloads having the same or similar deadline as the batch workload for the edge node, a higher customer priority can correspond to a relatively higher queue priority and a lower customer priority can correspond to a relatively lower queue priority.

At 303, the MEC compute service host is instructed to place the batch workload in the batch workload line. The MEC orchestration host can instruct the MEC compute service host to place the batch workload in the batch workload line according to the determined queue priority of the batch workload. In some embodiments, instructing the MEC compute service host to place the batch workload in the batch workload line can include sending a placement-instruction to the MEC compute service. The placement-instruction may include the determined queue priority of the batch workload.

At 304, the queue priority of the batch workload is increased in response to receiving an increase-priority request from the edge node. The MEC orchestration host can receive the increase-priority request from the edge node as the deadline is approaching (e.g., five minutes, 30 minutes, or the like, before the deadline) and the edge node has not received batch processing results. The increase-priority request can request the MEC orchestration host to increase the queue priority of the batch workload. The MEC orchestration host can increase the queue priority of the batch workload when receiving the increase-priority request. That is, the MEC orchestration host can move the batch workload up in the batch workload line for batch processing. For example, the batch workload may move ahead of some of the other batch workloads having higher customer priorities but later deadlines than the batch workload.

At 305, the batch workload is cancelled in response to receiving a cancel request from the edge node. The MEC orchestration host can receive the cancel request from the edge node as the deadline has been reached, e.g., the current time is later than the deadline, and the edge node has not received batch processing results. The cancel request can request the MEC orchestration host to cancel the batch processing of the data. The MEC orchestration host can cancel the batch workload when receiving the cancel request. In some embodiments, the processes at 305 can further include sending a cancel command to the MEC compute service host. The cancel command can instruct the MEC compute service host to remove the batch workload from the batch workload line.

In some embodiments, the method 300 may further include notifying the edge node that the batch workload has been canceled. The MEC orchestration host can send a cancel notification to the edge node to notify the batch workload has been successfully canceled. In some embodiments, when the register request does not include the deadline for the batch processing, the processes at 304 and 305 can be omitted.

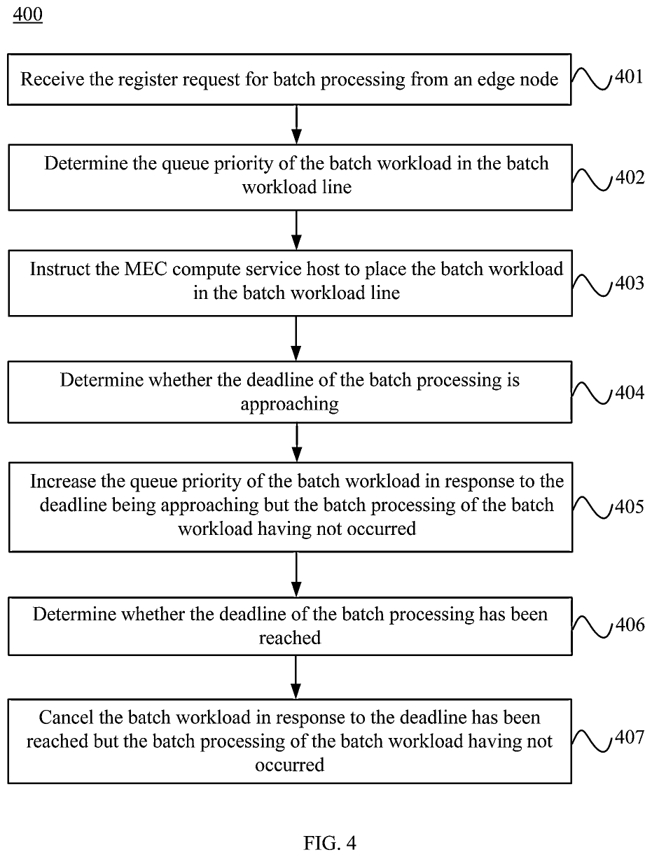

For further explanation, FIG. 4 shows another example batch processing method 400 for MEC orchestration consistent with the disclosure. The method 400 can be implemented by a MEC orchestration host of a batch processing system for MEC orchestration consistent with the disclosure, such as the MEC orchestration host 110 of the batch processing system 100 described above.

The difference between the method 300 in FIG. 3 and the method 400 in FIG. 4 lies in that the MEC orchestration host in FIG. 4 can automatically perform the increase of the queue priority and the cancellation of the batch workload on behalf of the edge node. Both methods 300 and 400 can realize the idea that when the deadline is approaching, the batch processing of the data can be prioritized ahead of some of the other batch workloads in the batch workload line.

As shown in FIG. 4, at 401, the register request for batch processing is received from the edge node. The MEC orchestration host can receive the register request from the edge node via the wireless network. The wireless connection can include Wi-Fi, Long Term Evolution (LTE), 4G, 5G, or the like. The register request may request the service of the MEC compute service host for batch processing of the data stored in the data buffer of the edge node. In some embodiments, the register request can further include the deadline for the batch processing. That is, the edge node can request the batch processing for the data stored in its data buffer to be performed before the deadline. The processes at 401 are similar to the processes at 301 and the detailed description thereof is omitted herein.

At 402, the queue priority of the batch workload in the batch workload line is determined. The MEC orchestration host can determine the queue priority of the batch workload in the batch workload line of the MEC compute service host. In some embodiments, the queue priority of the batch workload for the edge node can be determined according to the deadline. For example, the queue priority of the batch workload can be determined by comparing the deadline of the batch workload with those of the other batch workloads in the batch workload line. In some embodiments, the queue priority of the batch workload for the edge node can be determined according to the combination of the deadline and other factors (e.g., the customer priority indicating an importance of a customer and the like). The processes at 402 are similar to the processes at 302 and the detailed description thereof is omitted herein.

At 403, the MEC compute service host is instructed to place the batch workload in the batch workload line. The MEC orchestration host can instruct the MEC compute service host to place the batch workload in the batch workload line according to the determined queue priority of the batch workload. In some embodiments, instructing the MEC compute service host to place the batch workload in the batch workload line can include sending a placement-instruction to the MEC compute service. The placement-instruction may include the determined queue priority of the batch workload.

At 404, whether the deadline of the batch processing is approaching is determined. The MEC orchestration host can determine whether the deadline of the batch processing is approaching according to a time period left before the deadline and a time threshold. This time period is also referred to as a “remaining time period before the deadline” or simply a “remaining time period,” and can be a difference between a current time and the deadline in the scenario that the current time is still earlier than the deadline. For example, if the time period left before the deadline is equal to or smaller than the time threshold, the MEC orchestration host can determine that the deadline of the batch processing is approaching. If the time period left before the deadline is greater than the time threshold, the MEC orchestration host can determine that the deadline of the batch processing is not approaching. The time threshold can be determined according to actual needs. For example, the time threshold can be 30 minutes, and thus, when the time period left before the deadline is equal to or smaller than 30 minutes, the MEC orchestration host can determine that the deadline of the batch processing is approaching.

At 405, the queue priority of the batch workload is increased in response to the deadline being approaching but the batch processing of the data having not occurred. When the deadline is approaching but the batch processing of the data has not occurred, the MEC orchestration host can increase the queue priority of the batch workload. That is, the MEC orchestration host can move the batch workload up in the batch workload line for batch processing. For example, the batch workload may move ahead of some of the other batch workloads having higher customer priorities but later deadlines than this batch workload.

At 406, whether the deadline of the batch processing has been reached is determined. The MEC orchestration host can determine whether the deadline of the batch processing has been reached, e.g., whether the current time is later than the deadline. For example, if the time period left before the deadline is greater than zero, the MEC orchestration host can determine that the deadline of the batch processing has not been reached yet. If the time period left before the deadline is equal to zero, the MEC orchestration host can determine that the deadline of the batch processing has been reached.

At 407, the batch workload is cancelled in response to the deadline having been reached but the batch processing of the data having not occurred. When the deadline is reached but the batch processing of the data still has not occurred, the MEC orchestration host can cancel the batch workload. In some embodiments, the processes at 407 can further include sending the cancel command to the MEC compute service host. The cancel command can instruct the MEC compute service host to remove the batch workload from the batch workload line.

In some embodiments, the method 400 may further include notifying the edge node that the batch workload has been canceled. The MEC orchestration host can send the cancel notification to the edge node to notify the edge node that the batch workload has been successfully cancelled. In some embodiments, when the register request does not include the deadline for the batch processing, the processes at 404 to 407 can be omitted.

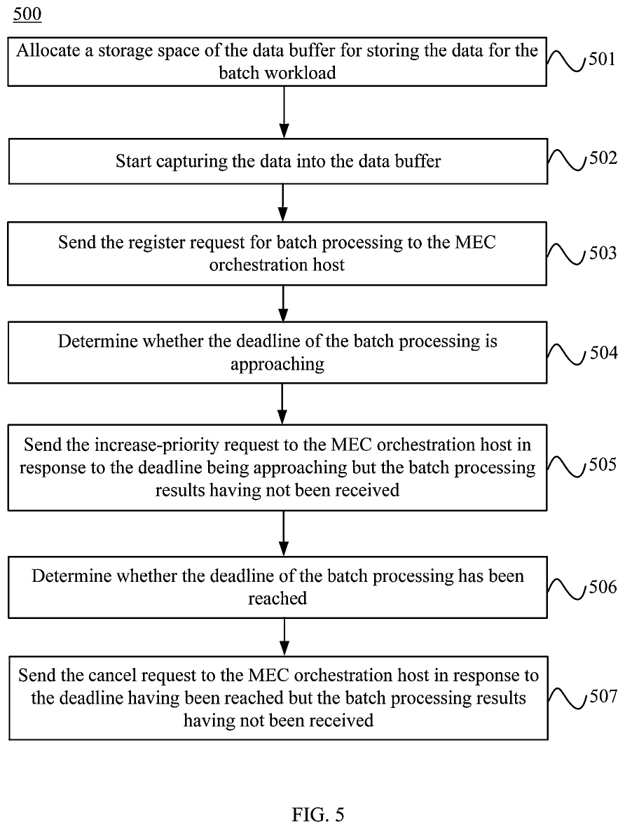

For further explanation, FIG. 5 shows another example batch processing method 500 for MEC orchestration consistent with the disclosure. The method 500 can be implemented by an edge node of a batch processing system for MEC orchestration consistent with the disclosure, such as anyone of the plurality of edge nodes 130-1 to 130-N of the batch processing system 100 described above.

As shown in FIG. 5, at 501, a storage space of the data buffer of the edge node is allocated for storing the data for the batch workload. The edge node can allocate part of or the entire data buffer of the edge node for storing the data for the batch workload.

At 502, capturing of the data into the data buffer is started. That is, after allocating the data buffer, the edge node can start capturing the data into the data buffer. For example, if the edge node is a video camera, the video camera can start capturing video images into its data buffer. Capturing the data into the data buffer can include obtaining the data and storing the data in the data buffer, e.g., in the allocated storage space of the data buffer.

At 503, the register request for batch processing is sent to the MEC orchestration host. The edge node can send the register request to the MEC orchestration host to inform the MEC orchestration host that the edge node has some data available that needs to be batch processed. The register request may request the service of the MEC compute service host for batch processing of data stored in the data buffer of the edge node. In some embodiments, the register request can further include the deadline for the batch processing. That is, the edge node can request the batch processing for the data stored in its data buffer to be performed before the deadline. The deadline can be determined based upon the capacity of the data buffer of the edge node or the amount of data captured per unit time.

At 504, whether the deadline of the batch processing is approaching is determined. The edge node can determine whether the deadline of the batch processing is approaching according to the time period left before the deadline and the time threshold. For example, if the time period left before the deadline is equal to or smaller than the time threshold, the edge node can determine that the deadline of the batch processing is approaching. If the time period left before the deadline is greater than the time threshold, the edge node can determine that the deadline of the batch processing is not approaching. The time threshold can be determined according to actual needs. For example, the time threshold can be 30 minutes, and thus, when the time period left before the deadline is equal to or smaller than 30 minutes, the edge node can determine that the deadline of the batch processing is approaching.

At 505, the increase-priority request is sent to the MEC orchestration host in response to the deadline being approaching but the batch processing results having not been received. If the deadline is approaching but the edge node has not received the batch processing results from the MEC compute service host, the edge node can send the increase-priority request to the MEC orchestration host. The increase-priority request can request the MEC orchestration host to increase the queue priority of the batch workload.

At 506, whether the deadline of the batch processing has been reached is determined. The edge node can determine whether the deadline of the batch processing has been reached. For example, if the time period left before the deadline being is greater than zero, the edge node can determine that the deadline of the batch processing has not been reached yet. If the time period left before the deadline is equal to zero, the edge node can determine that the deadline of the batch processing has reached.

At 507, the cancel request is sent to the MEC orchestration host in response to the deadline having been reached but the batch processing results having not been received. If the deadline has been reached but the edge node has not received the batch processing result from the MEC compute service host, the edge node can send the cancel request to the MEC orchestration host. The cancel request can request the MEC orchestration host to cancel the batch processing of the data.

In some embodiments, the method 500 may further include receiving, by the edge node, the cancel notification from the MEC orchestration host indicating that the batch workload has been canceled. In some embodiments, the MEC orchestration host (e.g., the MEC orchestration host in FIG. 4) can automatically perform the increase of the queue priority and the cancellation of the batch workload on behalf of the edge node, and hence the processes at 504 to 507 can be omitted.

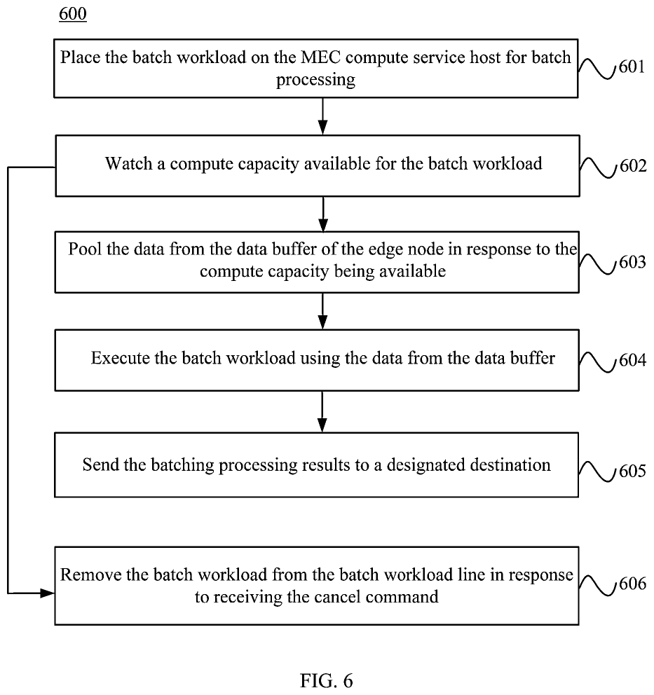

For further explanation, FIG. 6 shows another example batch processing method 600 for MEC orchestration consistent with the disclosure. The method 600 can be implemented by a MEC compute service host of a batch processing system for MEC orchestration consistent with the disclosure, such as the MEC compute service host 120 of the batch processing system 100 described above.

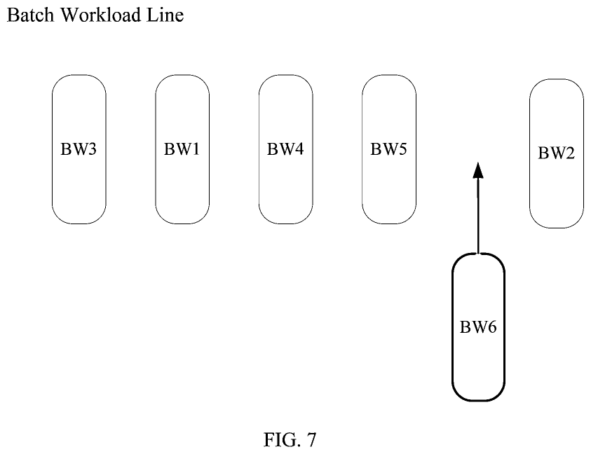

As shown in FIG. 6, at 601, the batch workload is placed on the MEC compute service host for batch processing. In some embodiments, the MEC compute service host can place the batch workload into the batch workload line in response to receiving the placement-instruction from the MEC orchestration host. The placement-instruction may include the determined queue priority of the batch workload. The MEC compute service host can place the batch workload into the batch workload line of the MEC compute service host according to the queue priority of the batch workload determined by the MEC orchestration host. The batch workload can be placed into the batch workload line at a position where the batch workloads ahead of it have the queue priorities higher than or equal to its queue priority and the batch workloads behind it have the queue priorities lower than its queue priority. FIG. 7 schematically illustrates placing the batch workload into the batch workload line consistent with the disclosure. As shown in FIG. 7, there are five batch workloads already in the batch workload line, i.e., BW1 to BW5, queued according to the queue priority order. Then a new batch workload, BW6, needs to be placed into the batch workload line. A queue priority of batch workload BW6 is lower than that of batch workload BW5 and higher than that of batch workload BW2. Thus, the new batch workload, BW6, can be placed between batch workload BW5 and batch workload BW2 in the batch workload line.

At 602, a compute capacity available for the batch workload is watched. The MEC compute service host can watch the compute capacity available for the batch workload.

At 603, the data is pooled from the data buffer of the edge node in response to the compute capacity being available. When the compute capacity of the MEC compute service host is available for the batch workload, the MEC compute service host can pool the data from the data buffer of the edge node for the batch processing.

At 604, the batch workload is executed using the data from the data buffer. The MEC compute service host can execute the batch workload using the data pooled from the data buffer. In some embodiments, if the cancel command is received from the MEC orchestration host during the process of executing the batch workload, the execution of the batch workload can be stopped.

At 605, the batching processing results are sent to a designated destination. The MEC compute service host can send the batching processing results to the designated destination when the execution of the batch workload is finished. In some embodiments, the designated destination can include a central data center, and the batching processing results can be relayed in the central data center for further storage, analysis, or reaction. In some other embodiments, the designated destination can include the edge node, and the batching processing results can be sent back to the edge node.

At 606, the batch workload is removed from the batch workload line in response to receiving the cancel command. In some embodiments, if the processes at 603 has not been performed yet but the cancel command from the MEC orchestration host is received, the MEC compute service host can remove the batch workload from the batch workload line. In these embodiments, the processes at 603 to 605 can be omitted. In some embodiments, if the cancel command is received from the MEC orchestration host during the process of pooling the data at 603, the execution of pooling the data can be stopped, and then the batch workload can be removed from the batch workload line.

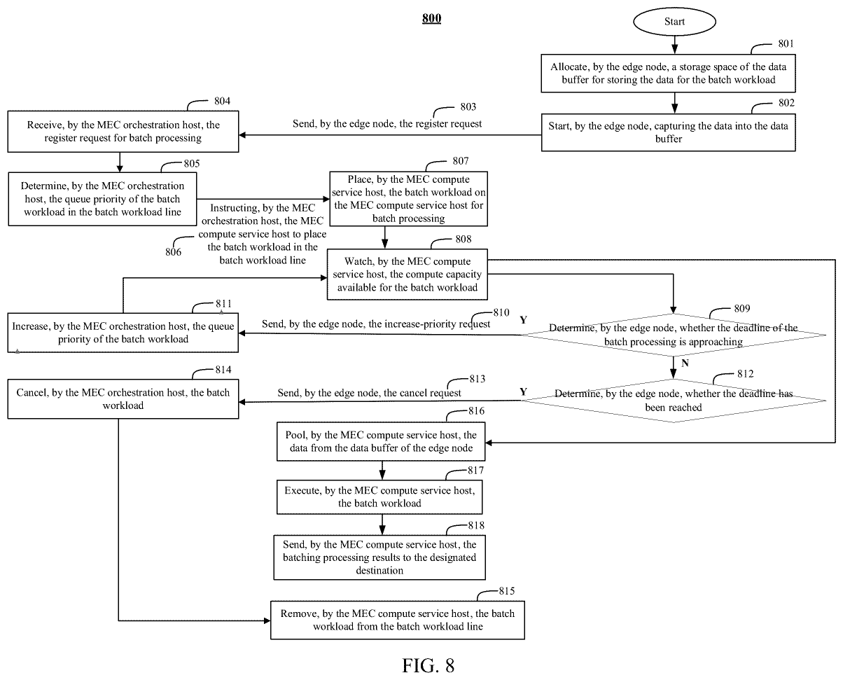

For further explanation, FIG. 8 shows an example working flow chart 800 of a batch processing system for MEC orchestration consistent with the disclosure. The batch processing system can be, for example, the batch processing system 100 described above. As shown in FIG. 8, at 801, the edge node allocates the storage space of its data buffer for storing data for the batch workload. The edge node can allocate part of or the entire data buffer for storing the data for the batch workload.

At 802, the edge node starts capturing the data into the data buffer.

At 803, the edge node sends the register request for batch processing to the MEC orchestration host. The edge node can send the register request to the MEC orchestration host to inform the MEC orchestration host that the edge node has some data available that needs to be batch processed. The register request may request the service of the MEC compute service host for batch processing of data stored in the data buffer of the edge node. In some embodiments, the register request can further include the deadline for the batch processing. That is, the edge node can request the batch processing for the data stored in its data buffer to be performed before the deadline. The deadline can be determined based upon the capacity of the data buffer of the edge node or the amount of data captured per unit time.

At 804, the MEC orchestration host receives the register request for batch processing from the edge node. The MEC orchestration host can receive the register request from the edge node via, e.g., the wireless network. The wireless connection can include Wi-Fi, Long Term Evolution (LTE), 4G, 5G, or the like.

At 805, the MEC orchestration host determines the queue priority of the batch workload in the batch workload line of the MEC compute service host. In some embodiments, the queue priority of the batch workload for the edge node can be determined according to the deadline. For example, the queue priority of the batch workload can be determined by comparing the deadline of the batch workload with those of other batch workloads in the batch workload line. In some embodiments, the queue priority of the batch workload for the edge node can be determined according to the combination of the deadline and other factors (e.g., the customer priority indicating an importance of a customer or the like).

At 806, the MEC orchestration host instructs the MEC compute service host to place the batch workload in the batch workload line. The MEC orchestration host can instruct the MEC compute service host to place the batch workload in the batch workload line according to the determined queue priority of the batch workload. In some embodiments, instructing the MEC compute service host to place the batch workload in the batch workload line can include sending a placement-instruction to the MEC compute service. The placement-instruction may include the determined queue priority of the batch workload.

At 807, the MEC compute service host places the batch workload on the MEC compute service host for batch processing. In some embodiments, the MEC compute service host can place the batch workload into the batch workload line in response to receiving the placement-instruction from the MEC orchestration host. The placement-instruction may include the determined queue priority of the batch workload. The MEC compute service host can place the batch workload into the batch workload line of the MEC compute service host according to the queue priority of the batch workload determined by the MEC orchestration host. The batch workload can be placed into the batch workload line at the position where the batch workloads ahead of it have the queue priorities higher than or equal to its queue priority and the batch workloads behind it have the queue priorities lower than its queue priority.

At 808, the MEC compute service host watches the compute capacity available for the batch workload. The MEC compute service host can watch the compute capacity available for the batch workload.

At 809, the edge node determines whether the deadline of the batch processing is approaching. The edge node can determine whether the deadline of the batch processing is approaching according to the time period left before the deadline and the time threshold. For example, if the time period left before the deadline is equal to or smaller than the time threshold, the edge node can determine that the deadline of the batch processing is approaching. If the time period left before the deadline is greater than the time threshold, the edge node can determine that the deadline of the batch processing is not approaching. The time threshold can be determined according to actual needs.

At 810, the edge node sends the increase-priority request to the MEC orchestration host in response to the deadline being approaching but the batch processing results having not been received. If the deadline is approaching but the edge node has not received the batch processing results from the MEC compute service host, the edge node can send the increase-priority request to the MEC orchestration host. The increase-priority request can request the MEC orchestration host to increase the queue priority of the batch workload.

At 811, the MEC orchestration host increases the queue priority of the batch workload in response to receiving the increase-priority request from the edge node. The MEC orchestration host can move the batch workload up in the batch workload line for batch processing. For example, the batch workload may move ahead of some of the other batch workloads having higher customer priorities but later deadlines than the batch workload.

At 812, the edge node determines whether the deadline of the batch processing has been reached. The edge node can determine whether the deadline of the batch processing has been reached. For example, if the time period left before the deadline is greater than zero, the edge node can determine that the deadline of the batch processing has not been reached yet. If the time period left before the deadline is equal to zero, the edge node can determine that the deadline of the batch processing has been reached.

At 813, the edge node sends the cancel request to the MEC orchestration host in response to the deadline having been reached but the batch processing results having not been received. If the deadline has been reached but the edge node has not received the batch processing result from the MEC compute service host, the edge node can send the cancel request to the MEC orchestration host. The cancel request can request the MEC orchestration host to cancel the batch processing of the data.

At 814, the MEC orchestration host cancels the batch workload in response to receiving the cancel request from the edge node. The MEC orchestration host can cancel the batch workload when receiving the cancel request. In some embodiments, the processes at 814 can further include sending the cancel command to the MEC compute service host. The cancel command can instruct the MEC compute service host to remove the batch workload from the batch workload line.

At 815, the MEC compute service host removes the batch workload from the batch workload line in response to receiving the cancel command.

If the processes at 815 has not been performed yet, i.e., the batch workload is still in the batch workload line, the method 800 can further include the processes at 816 to 818.

At 816, the MEC compute service host pools the data from the data buffer of the edge node in response to the compute capacity being available. When the compute capacity of the MEC compute service host is available for the batch workload, the MEC compute service host can pool the data from the data buffer of the edge node for the batch processing.

At 817, the MEC compute service host executes the batch workload using the data from the data buffer. The MEC compute service host can execute the batch workload using the data pooled from the data buffer.

At 818, the MEC compute service host sends the batching processing results to the designated destination. The MEC compute service host can send the batching processing results to the designated destination when the execution of the batch workload is finished. In some embodiments, the designated destination can include the central data center, and the batching processing results can be relayed in the central data center for further storage, analysis, or reaction. In some other embodiments, the designated destination can include the edge node, and the batching processing results can be sent back to the edge node.

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, or the like) or an embodiment combining software and hardware aspects that may all generally be referred to herein as a “circuit,” “module,” or “system.” Furthermore, aspects of the present disclosure may take the form of a computer program product embodied in one or more computer readable medium(s) having computer readable program code embodied thereon.

Any combination of one or more computer readable storage medium(s) may be utilized. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device. Furthermore, any program instruction or code that is embodied on such computer readable storage medium (including forms referred to as volatile memory) is, for the avoidance of doubt, considered “non-transitory.”

Program code embodied on a computer readable storage medium may be transmitted using any appropriate medium, including but not limited to wireless, wireline, optical fiber cable, RF, or the like, or any suitable combination of the foregoing. Computer program code for carrying out operations for aspects of the present disclosure may be written in any combination of one or more programming languages, including an object oriented programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure may be described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, and/or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored as non-transitory program instructions in a computer readable storage medium that can direct a computer, other programmable data processing apparatus, or other devices to function in a particular manner, such that the program instructions stored in the computer readable storage medium produce an article of manufacture including non-transitory program instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The terminology used herein is for the purpose of describing particular embodiments only and is not intended to be limiting the disclosure. As used herein, the singular forms “a” and “an” are intended to include the plural forms as well, unless the context clearly indicates otherwise. It will be further understood that the terms “comprises” and/or “comprising,” when used in this specification, specify the presence of stated features, integers, steps, operations, elements, components and/or groups, but do not preclude the presence or addition of one or more other features, integers, steps, operations, elements, components, and/or groups thereof. The terms “optionally,” “may,” and similar terms are used to indicate that an item, condition or step being referred to is an optional (not required) feature of the disclosure.

Other embodiments of the disclosure will be apparent to those skilled in the art from consideration of the specification and practice of the embodiments disclosed herein. It is intended that the specification and examples be considered as exemplary only and not to limit the scope of the disclosure, with a true scope and spirit of the invention being indicated by the following claims.

What is claimed is:

1. A batch processing method comprising:
receiving a register request from an edge node, the register request requesting a service of a Multi-Access Edge Computing (MEC) compute service host for batch processing of edge-node data stored in a data buffer of the edge node;
determining a queue priority of a batch workload for batch processing of the edge-node data in a batch workload line of the MEC compute service host; and
instructing the MEC compute service host to place the batch workload in the batch workload line according to the determined priority.

2. The method of claim 1, further comprising:
increasing the queue priority of the batch workload in response to receiving an increase-priority request from the edge node.

3. The method of claim 1, further comprising:
cancelling the batch workload in response to receiving a cancel request from the edge node.

4. The method of claim 1, wherein the register request includes a deadline for the batch processing of the edge-node data.

5. The method of claim 4, wherein the deadline is determined based upon at least one of a capacity of the data buffer of the edge node or an amount of data captured per unit time.

6. The method of claim 4, wherein determining the queue priority of the batch workload includes determining the queue priority of the batch workload according to at least one of the deadline or a customer priority indicating an importance of a customer to whom the edge node belongs.

7. The method of claim 4, further comprising:
determining whether the deadline is approaching; and
increasing the queue priority of the batch workload in response to the deadline being approaching but the batch processing having not occurred.

8. The method of claim 4, further comprising:
determining whether the deadline has been reached; and
cancelling the batch workload in response to the deadline having been reached but the batch processing having not occurred.

9. A batch processing method comprising:
allocating a data buffer for a batch workload;
starting capturing data into the data buffer; and
sending a register request to a Multi-Access Edge Computing (MEC) orchestration host, the register request requesting a service of a MEC compute service host for batch processing of the data stored in the data buffer.

10. The method of claim 9, wherein the register request includes a deadline for the batch processing of the data.

11. The method of claim 10, wherein the deadline is determined based upon at least one of a capacity of a data buffer of an edge node or an amount of data captured per unit time.

12. The method of claim 10, further comprising:
determining whether the deadline of the batch processing is approaching; and
sending an increase-priority request to the MEC orchestration host in response to the deadline being approaching but corresponding batch processing results having not been received.

13. The method of claim 10, further comprising:
determining whether the deadline of the batch processing has been reached; and
sending a cancel request to the MEC orchestration host in response to the deadline having been reached but corresponding batch processing results having not been received.

14. A Multi-Access Edge Computing (MEC) orchestration host comprising:
at least one memory; and
at least one processor coupled to the at least one memory and configured to:
receive a register request from an edge node, the register request requesting a service of a MEC compute service host for batch processing of edge-node data stored in a data buffer of the edge node;
determine a queue priority of a batch workload for batch processing of the edge-node data in a batch workload line of the MEC compute service host; and
instruct the MEC compute service host to place the batch workload in the batch workload line according to the determined priority.

15. The MEC orchestration host of claim 14, wherein the at least one processor is further configured to:
increase the queue priority of the batch workload in response to receiving an increase-priority request from the edge node.

16. The MEC orchestration host of claim 14, wherein the at least one processor is further configured to:
cancel the batch workload in response to receiving a cancel request from the edge node.

17. The MEC orchestration host of claim 14, wherein the register request includes a deadline for the batch processing of the edge-node data.

18. The MEC orchestration host of claim 17, wherein the deadline is determined based upon at least one of a capacity of the data buffer of the edge node or an amount of data captured per unit time.

19. The MEC orchestration host of claim 17, wherein the at least one processor is further configured to determine the queue priority of the batch workload according to at least one of the deadline or a customer priority indicating an importance of a customer to whom the edge node belongs.

20. The MEC orchestration host of claim 17, wherein the at least one processor is further configured to:
determine whether the deadline is approaching;
increase the queue priority of the batch workload in response to the deadline being approaching but the batch processing having not occurred;
determine whether the deadline has been reached; and
cancel the batch workload in response to the deadline having been reached but the batch processing having not occurred.
